(19) United States
(12) Patent Application Publication
(10) Pub. No.: US 2007/0076361 A1
(43) Pub. Date: Apr. 5, 2007

(54) Computer device with input/output cover

(76) Inventor: Memphis-Zhihong Yin, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/240,143

(22) Filed: Sep. 30, 2005

(51) Int. Cl. G06F 1/16

(52) U.S. Cl. 361/683

(57) ABSTRACT

A computer device comprising a housing having a peripheral opening with a least one input/output (I/O) port disposed therein and a cover removably couplable to a periphery of the housing to enclose the peripheral opening, the cover having at least one opening formed therein corresponding to a location of the at least one I/O port.

### BACKGROUND OF THE INVENTION

Portable computer devices, such as notebook or laptop computers, comprise a base member having one or more input/output (I/O) ports to facilitate connections between internal components of the computer device and external devices (e.g., a printer, mouse, web camera, or power source). Because different models of computer devices oftentimes comprise different numbers, types, sizes and/or locations of such I/O ports, the base member must be re-tooled and/or redesigned to accommodate the new and/or different I/O port configuration, thereby resulting in extensive inventory management issues and significant tooling and design costs.

### BRIEF DESCRIPTION OF THE DRAWINGS

For a more complete understanding of the present invention, and the objects and advantages thereof, reference is now made to the following descriptions taken in connection with the accompanying drawings in which:

FIG. 1 is a front perspective view of a computer device employing an embodiment of an input/output (I/O) cover to advantage in accordance with the present invention;

FIG. 2 is a front perspective view of a computer device employing another embodiment of an I/O cover to advantage in accordance with the present invention;

FIG. 3 is a front perspective view of the I/O cover of FIG. 2 partially secured to the computer device;

FIG. 4a is an enlarged view illustrating an embodiment of an I/O cover locking mechanism in accordance with the present invention;

FIG. 4b is an enlarged view illustrating another embodiment of an I/O cover locking mechanism in accordance with the present invention;

FIG. 4c is a section view of the I/O cover locking mechanism of FIG. 4b; and

FIG. 4d is an enlarged view of another embodiment of an I/O cover locking mechanism in accordance with the present invention.

### DETAILED DESCRIPTION OF THE DRAWINGS

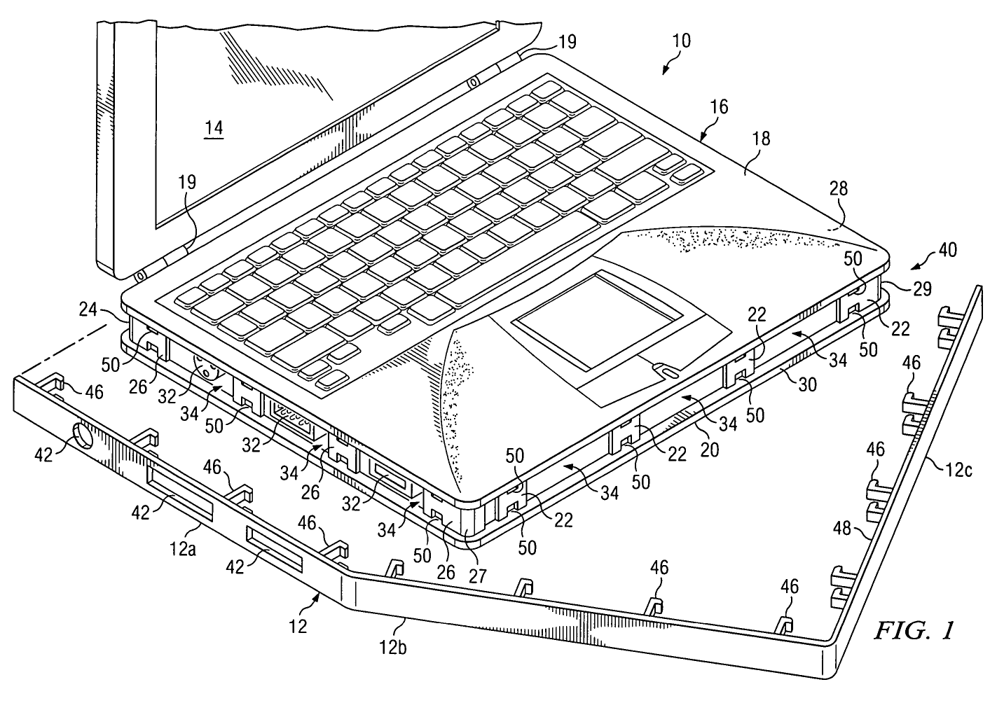

The preferred embodiments of the present invention and the advantages thereof are best understood by referring to FIGS. 1-4d of the drawings, like numerals being used for like and corresponding parts of the various drawings.

FIG. 1 is a front perspective view of a computer device 10 employing an embodiment of an input/output (I/O) cover 12 to advantage in accordance with the present invention. In the embodiment illustrated in FIG. 1, computer device 10 comprises a portable computer device such as a laptop or notebook computer, tablet computer, or other type handheld computing device. However, it should be understood that computer device 10 may comprise other types of portable or non-portable computer devices. In the embodiment illustrated in FIG. 1, computer device 10 comprises a display member 14 rotatably coupled to a base member 16 by hinges 19. Base member 16 comprises a housing 30 having a working surface 18, a bottom surface 20, a front surface 22, a rear surface 24, and side surfaces 26 and 28. Base member 16 also comprises I/O ports 32 corresponding to a number of different internal components of computer device 10 such as, but not limited to, a disk drive interface (e.g., drive bay), a video interface, an audio interface, a digital video disk (DVD) player interface and a communications port to facilitate communicative coupling of such internal components to various types of external devices (e.g., a mouse, printer or monitor). Generally, housing 30 is formed having a number of locations and/or openings 34 to facilitate locations of such internal components of computer device 10 and facilitate external access and/or communication therewith (e.g., via corresponding I/O ports 32 associated with such internal components).

In the embodiment illustrated in FIG. 1, housing 30 comprises a peripheral opening 40 extending along at least a portion of housing 30 formed along or near surfaces 18 and 20 and surfaces 22, 24, 26 or 28 (or any combination thereof). In the embodiment illustrated in FIG. 1, opening 40 extends along three sides (e.g., surfaces 22, 26 and 28) of computer device 10. However, it should be understood that opening 40 may extend around the entire periphery of computer device 10 or to a fewer number of sides, or extending partially along a dimension of one or more sides, of computer device 10. In the embodiment illustrated in FIG. 1, I/O ports 32 are disposed along surfaces 26 and 28 of housing 30 within opening 40. However, it should be understood that I/O ports 32 may be disposed alternately, or additionally, along surfaces 22 and/or 24. Further, it should be understood that the locations of internal components within housing 30 of computer device 10 may be different for different computer devices (e.g., different models of computer devices and/or different types of computer devices), thereby correspondingly changing a location of respective I/O ports 32 relative to housing 30. Embodiments of the present invention provide I/O covers 12 configured to correspond to the different I/O port 32 configurations such that a re-design and/or remold of base member 16 for different I/O port 32 configurations is unnecessary. Thus, embodiments of the present invention enable different I/O port 32 configurations to be designed and/or implemented for different computer devices and/or models of computer device using a single housing (e.g., housing 30) such that different I/O covers 12 correspondingly configured for the different I/O port 32 configurations are readily attachable to such housing. Further, in the embodiment illustrated in FIG. 1, opening 40 is illustrated as being recessed relative to an outermost periphery of housing 30. However, it should be understood that opening 40 may be otherwise formed (e.g., flush with an outermost periphery of housing 30 and/or extending slightly outwardly therefrom).

In the embodiment illustrated in FIG. 1, cover 12 comprises portions 12a, 12b and 12c adapted to cooperate with surfaces 26, 22 and 28, respectively, such that cover 12 is disposed at least partially within opening 40. However, it should be understood that interchangeable cover 12 may be otherwise configured. For example, cover 12 may comprise a single portion 12a disposed only on surface 26 (or a portion thereof), or a double portion 12a and 12b disposed on surfaces 26 and 22, respectively (or a portion of each of surface 26 and 22). In some embodiments of the present invention, interchangeable I/O cover 12 is preferably constructed and/or otherwise fabricated from a flexible material to facilitate conforming or “wrapping” of cover 12 over surface 26 and around corner 27 to cover surface 22 and around corner 29 to cover surface 28. However, it should also be understood that cover 12 may be rigidly or semi-rigidly constructed. Furthermore, it should be understood that alternatively, or additionally, cover 12 may be attached to any combination of surfaces 22, 24, 26 and/or 28 and, accordingly, in some embodiments of the present invention, opening 40 may be omitted from one or more of surfaces 22, 24, 26 and 28.

In the embodiment illustrated in FIG. 1, cover 12 comprises openings 42 adapted to correspond to locations of I/O ports 32 when cover 12 is disposed over surfaces 22, 26 and/or 28 and within opening 40. The unused openings 34 are covered by portions 12a, 12b and 12c so as to enclose housing 30 while also providing an aesthetically pleasing appearance to the end user. It should be understood that the quantity of I/O ports 32 and correspondingly configured openings 42 in I/O cover 12 may vary (e.g., a single I/O port 32 and correspondingly configured single opening 42 in I/O cover 12, two I/O ports 32 and correspondingly configured two openings 42 in I/O cover 12 residing on a same side, different sides and/or multiple sides of housing 30 and/or a greater quantity of I/O ports 32 and correspondingly configured openings 42 in I/O cover 12). In the embodiment illustrated in FIG. 1, cover 12 is seated flush (or substantially flush) within opening 40.

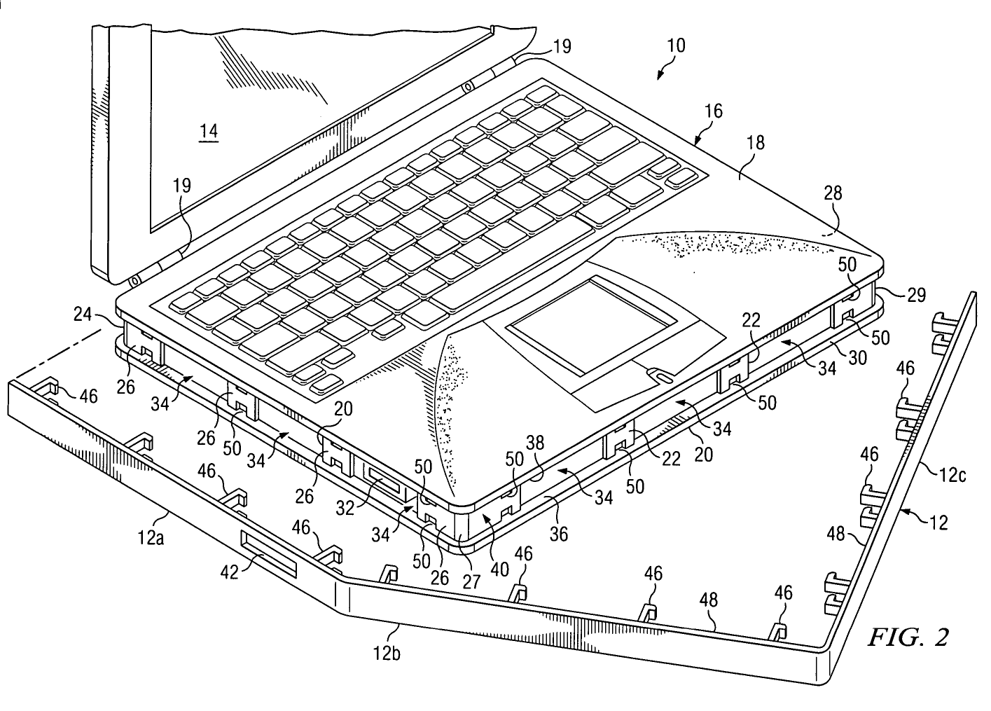

FIG. 2 is a front perspective view of a computer device 10 employing another embodiment of an interchangeable I/O cover 12 to advantage in accordance with the present invention. In the embodiment illustrated in FIG. 2, housing 30 comprises a single I/O port 32 disposed on surface 26 of housing 30. Interchangeable I/O cover 12 comprises a single opening 42 that corresponds in size, shape and location to such I/O port 32 while unused openings 34 disposed on surfaces 22, 26, and 28 of housing 30 are covered by respective portions 12a, 12b and 12c of cover 12 to enclose housing 30 and provide an aesthetically pleasing appearance of computer device 10. Accordingly, an identical base member 16 can be adapted for use with differing numbers, types, and/or locations of internal components without having to re-design a new base member 16 to correspond to a different number, type and/or location of the internal components or fabricating separate individual covers to cover each unused opening 34.

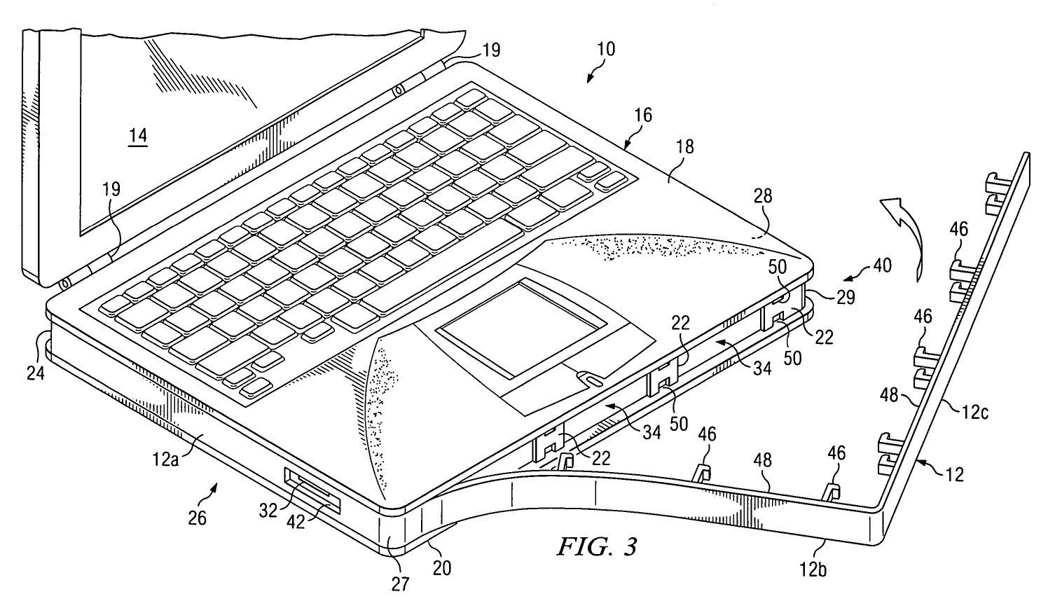

FIG. 3 is a front perspective view of the interchangeable I/O cover 12 of FIG. 2 partially secured to computer device 10 in accordance with an embodiment of the present invention. In the embodiment illustrated in FIG. 3, portion 12a of cover 12 is disposed within opening 40 located along surface 26 of housing 30 and coupled to base member 16 such that opening 42 aligns with I/O port 32. Portion 12a extends the entire length of surface 26 and wraps around corner 27 so as to enable portion 12b to enclose openings 34 on surface 22, and to further wrap around corner 29 so that portion 12c covers openings 34 on surface 28.

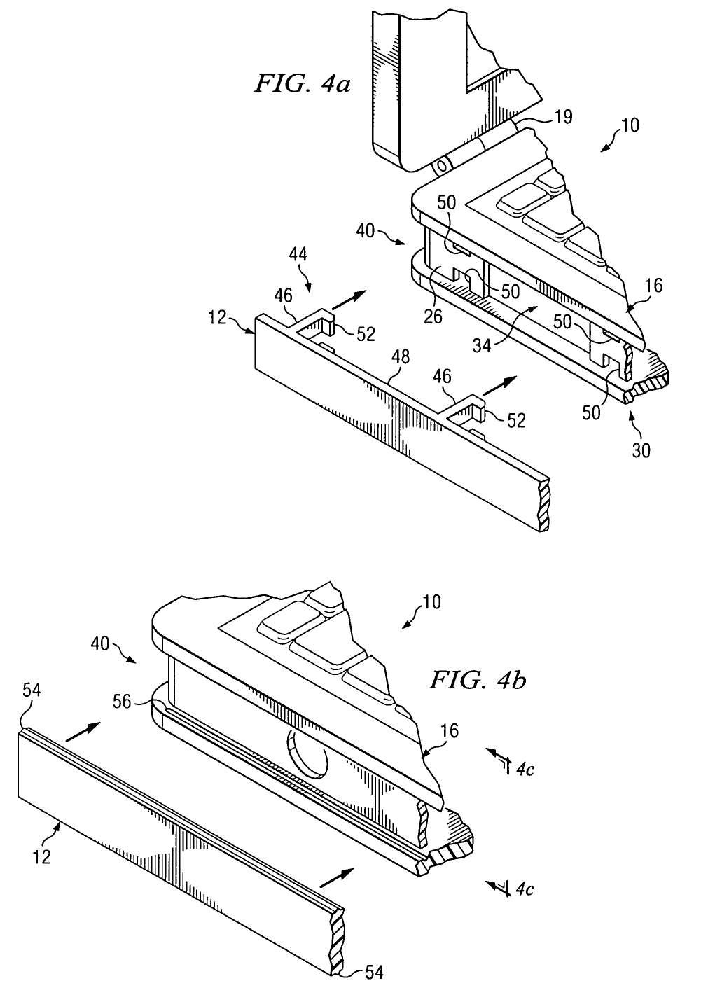

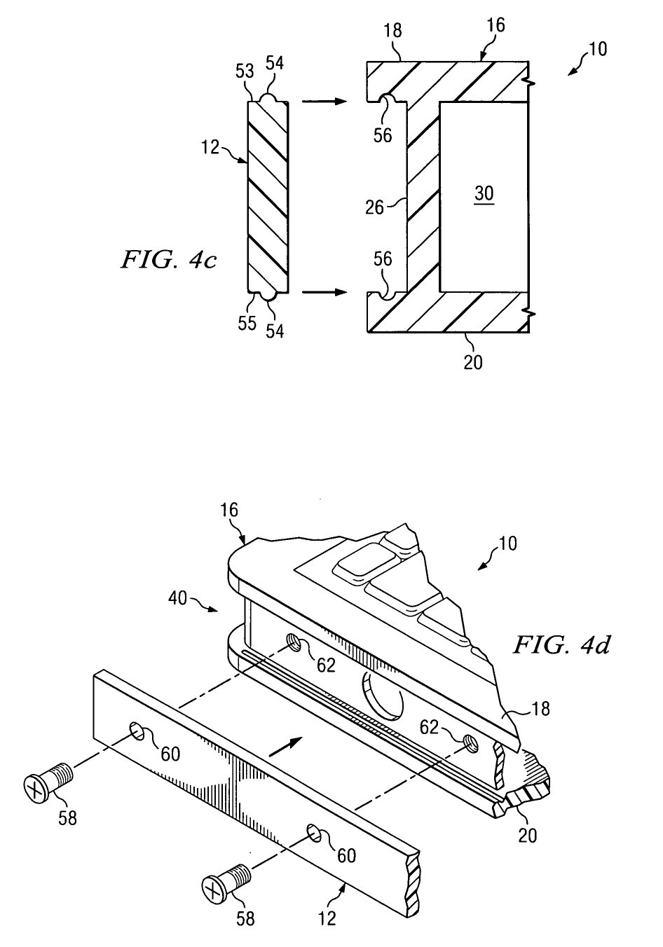

FIG. 4a is an enlarged view of a portion of the computer device of FIG. 1 illustrating an embodiment of an I/O cover locking mechanism 44 in accordance with the present invention. In the embodiment illustrated in FIG. 4a, locking mechanism 44 releasably secures cover 12 to base member 16. In the embodiment illustrated in FIG. 4A, locking mechanism 44 comprises a plurality of catches 46 disposed on an interior surface 48 of cover 12 corresponding to locations of respective openings 50 disposed on surfaces 22, 26 and 28 of housing 30. In operation, catches 46 are aligned with and inserted inside openings 50 so that hooks 52 disposed on the ends of catches 46 engage openings 50 to securely fasten interchangeable I/O cover 12 to base member 16.

FIGS. 4b and 4c are enlarged views of computer device 10 illustrating yet another embodiment of I/O cover locking mechanism 44 in accordance with the present invention. In the embodiment illustrated in FIGS. 4b and 4c, locking mechanism 44 comprises detents 54 disposed on opposing upper and lower surfaces 53 and 55, respectively, of cover 12 for engaging grooves 56 formed on respective upper and lower surfaces of housing 30. Preferably, cover 12 is manufactured having a desired level of flexibility to accommodate insertion of cover 12 within opening 40 and deformation of cover 12 to facilitate engagement of detents 54 with grooves 56 to securely fasten cover 12 to base member 16.

FIG. 4d is an enlarged perspective view of computer device 10 illustrating yet another embodiment of I/O cover locking mechanism 44 in accordance with the present invention. In the embodiment illustrated in FIG. 4d, locking mechanism 44 comprises screws 58 to securely fasten cover 12 to base member 16. Cover 12 is positioned within opening 40 such that openings 60 formed on cover 12 are co-axially aligned with threaded openings 62 formed on base member 16 such that screws 58 are used to securely fasten cover 12 to base member 16. Thus, it should be understood that a number of different methods and/or devices may be used to releasably secure cover 12 to housing 30.

Thus, embodiments of the present invention enable a single computer housing to be used with a number of different internal component configurations. Further, embodiments of the present invention enable a change to the size, shape and/or location of such internal components without necessitating a change to the housing (e.g., by utilizing a correspondingly configured I/O cover 12). Accordingly, when different models of computer devices 10 are manufactured (e.g., computer devices 10 having different numbers, sizes, locations and/or shapes of internal components, thereby resulting in different numbers, sizes, locations and/or shapes of I/O ports 32), an identical base member 16 for each model of computer and correspondingly configured I/O cover 12 may be used to accommodate the different numbers, sizes, locations and/or shapes of such I/O ports 32. In addition, embodiments of the present invention reduce the number of parts forming computer device 10.

What is claimed is:

1. A computer device, comprising:
a housing having a peripheral opening with a least one input/output (I/O) port disposed therein; and
a cover removably couplable to a periphery of the housing to enclose the peripheral opening, the cover having at least one opening formed therein corresponding to a location of the at least one I/O port.

2. The computer device of claim 1, wherein the cover extends along an entire dimension of at least one surface of the housing.

3. The computer device of claim 1, wherein the cover is flexible.

4. The computer device of claim 1, wherein the cover extends to at least two surfaces of the housing.

5. The computer device of claim 1, wherein the cover extends around at least one corner of the housing.

6. The computer device of claim 1, further comprising a locking mechanism to releasably secure the cover to the housing.

7. The computer device of claim 1, wherein the peripheral opening extends to at least two surfaces of the computer device.

8. The computer device of claim 1, wherein the housing comprises a base member housing of a portable computer.

9. A computer device comprising:
a housing means having a peripheral opening with a least one input/output (I/O) port disposed therein; and
means removably couplable to a periphery of the housing means for enclosing the peripheral opening, the enclosing means having at least one opening formed therein corresponding to a location of the at least one I/O port.

10. The computer device of claim 9, wherein the enclosing means extends an entire dimension of at least one surface of the housing means.

11. The computer device of claim 9, wherein the enclosing means is flexible.

12. The computer device of claim 9, wherein the enclosing means extends to at least two surfaces of the housing means.

13. The computer device of claim 9, wherein the enclosing means extends around at least one corner of the housing means.

14. A method of manufacturing a computer device, comprising:
providing a housing having a peripheral opening with a least one input/output (I/O) port disposed therein; and
removably coupling a cover to a periphery of the housing to enclose the peripheral opening, the cover having at least one opening formed therein corresponding to a location of the at least one I/O port.

15. The method of claim 14, further comprising flexibly configuring the cover.

16. The method of claim 14, wherein removably coupling the cover to the housing comprises extending the cover to at least two surfaces of the housing.

17. The method of claim 14, wherein removably coupling the cover to the housing comprises extending the cover around at least one corner of the housing.

18. The method of claim 14, wherein providing a housing comprises providing a portable computer housing.

19. A method of manufacturing a computer device, comprising:
providing a housing having a peripheral opening, the housing adapted to support a plurality of different input/output (I/O) port configurations relative to the peripheral opening; and
coupling a select one of a plurality of differently configured I/O covers to the housing, the select one of the plurality of differently configured I/O covers configured to correspond to at least one of the plurality of different I/O port configurations.

20. The method of claim 19, further comprising coupling the select one of the plurality of differently configured I/O covers to at least two surfaces of the housing.

21. The method of claim 19, further comprising extending the select one of the plurality of differently configured I/O covers around at least one corner of the computer device.

22. The method of claim 19, further comprising coupling the select one of the plurality of differently configured I/O covers to base member housing of a portable computer device.

23. A computer device, comprising:
a housing having a peripheral opening, the housing adapted to support a plurality of different input/output (I/O) port configurations relative to the peripheral opening; and
a select one of a plurality of differently configured I/O covers couplable to the housing, the select one of the plurality of differently configured I/O covers configured to correspond to at least one of the plurality of different I/O port configurations.

24. The computer device of claim 23, wherein the select one of the plurality of differently configured I/O covers extends to at least two surfaces of the housing.

25. The computer device of claim 23, wherein the select one of the plurality of differently configured I/O covers extends around at least one corner of the housing.

26. The computer device of claim 23, wherein the select one of the plurality of differently configured I/O covers is flexibly configured.

27. The computer device of claim 23, further comprising a locking mechanism configured to releasably secure the select one of the plurality of differently configured I/O covers to the housing.
